(19) United States
(12) Patent Application Publication
(10) Pub. No.: US 2014/0098836 A1
(43) Pub. Date: Apr. 10, 2014

(54) TEMPERATURE INDICATING PAINT

(71) Applicant: Colin Bird, Derby (GB)

(72) Inventor: Colin Bird, Derby (GB)

(73) Assignee: ROLLS-ROYCE PLC, London (GB)

(21) Appl. No.: 14/118,320

(22) PCT Filed: May 30, 2012
(86) PCT No.: PCT/EP2012/060100

§ 371 Date: Nov. 18, 2013

(30) Foreign Application Priority Data
Jun. 8, 2011 (GB) 1109533.8

(51) Int. Cl. C09D 5/26; G01K 11/06

(52) U.S. Cl. CPC C09D 5/26; G01K 11/06
USPC 374/137; 252/408.1; 374/160

(57) ABSTRACT

A temperature indicating paint is provided. The paint is spreadable onto a surface of an article. The paint includes particles of an alloy of two or more metals. The particles vary in relative composition of the metals such that particles having different compositions have different solidus and liquidus melting temperatures.

The present invention relates to a temperature indicating paint.

Known irreversible temperature indicating paints change colour at one or more known temperatures. These colour changes indicate the temperature to which different parts of a component or components have been subjected. The paint can be applied to components such as turbine blades, turbine vanes and combustors of gas turbine engines.

The paint helps determination of the temperatures to which different regions of the component reached during the test. Advantageously, the paint can produce a temperature profile over the whole surface of the component, rather than at discrete points if for example thermocouples were used.

One known irreversible temperature indicating paint is described in U.S. 2010/0276642 and comprises sodium alumino sulpho silicate, nickel antimony titanate and a binder. The paint undergoes colour change at 520-560° C., 950-990° C., 1000-1040° C. and 1160-1200° C. However, the final colour of such a paint is generally dependent on both the temperature it is subjected to and the time period over which it is held at a raised temperature. This time dependence introduces errors when the time-temperature history of the component is not well known. Further, a requirement for a fixed, generally short, thermal excursion reduces the flexibility of how such paints can be used.

Another known temperature indicating paint is described in GB A 2204874 and comprises one or more of silver, gold, platinum, copper, nickel, chromium, titanium and silicon dispersed in 10 to 70 wt % solvent and resin. This type of paint tends to have just one change of colour or finish, but the change is substantially independent of the time period over which the component is held at a raised temperature. Thus the paint can provide one isotherm on the component e.g. from which the colour change of the first type of temperature indicating paint can be calibrated. However, as the paint exhibits only one isotherm, the information gained from use of the paint is relatively low. Further, such paints are unsuitable for components with uniform temperature distributions (which may not traverse the isotherm).

There is a need for a further type of temperature indicating paint which addresses at least some of the shortcomings noted above.

Accordingly, the present invention provides in a first aspect a temperature indicating paint which is spreadable onto a surface of an article, the paint including particles of an alloy of two or more metals, the particles varying in relative composition of the metals such that particles having different compositions have different melting points or melting ranges.

Advantageously, each composition can denote respective solidus and liquidus points. When applied as a coating to an article and then exposed to temperature, those particles whose solidus points are above the maximum temperature at a given location will remain completely unmelted, while those particles whose solidus points are below the maximum temperature at the location will begin to melt and lose their shape. Those particles whose liquidus points are below the maximum temperature at a given location will be completely melted and will lose their shape. Thus identifying the particles that have remained partially or fully unmelted and determining the lowest melting point of those particles allows the maximum temperature at a given location to be determined. Repeating the procedure at other locations then allows a 2-D map of maximum temperatures across the article to be derived. Time dependence in the maximum temperature determination is expected to be weak or non-existent.

The paint may have any one or, to the extent that they are compatible, any combination of the following optional features.

Typically, the paint includes a matrix for the particles. For example, the matrix can include components such as inert fillers to reduce interactions between particles in the paint.

Conveniently, the particles having different compositions may be distinguishable from each other by spectroscopy, e.g. energy dispersive X-ray spectroscopy, auger electron spectroscopy, X-ray photoelectron spectroscopy or wavelength dispersive X-ray spectroscopy. Such spectroscopic techniques can be combined with e.g. secondary electron microscopy to identify the unmelted particles.

The alloy may be an alloy of just two metals.

Preferably, the particles provide a continuous distribution of compositions and a corresponding continuous distribution of solidus and liquidus points. For example, one end point of the composition distribution may have a lower melting point than the other end point of the composition distribution, and the alloy may have continuously increasing solidus and liquidus lines between the end points. In this way, each composition can have a unique melting range.

The melting ranges of the particles may be at least 500° C., and preferably at least 800° C. or 900° C. The melting points of the particles may be at most 1400° C., and preferably at most 1300° C. or 1200° C. These temperature limits can provide a range of particle melting points which are suitable for investigating maximum temperatures in gas turbine engines.

In a second aspect, the present invention provides the use of the paint according to the first aspect for painting the surface of an article. For example, the article may be a gas turbine engine component such as a turbine blade or vane, turbine disc, or combustor.

In a third aspect, the present invention provides an article having a surface painted with the paint according to the first aspect. Again, the article may be a gas turbine engine component such as a turbine blade or vane, turbine disc, or combustor

In a fourth aspect, the present invention provides a method of producing the paint according to the first aspect, the method including the steps of:

sputtering a substrate with two metals or metal alloys having different compositions such that a sputtered deposit is formed on the substrate, the sputtering conditions being selected such that the deposit varies in relative composition of the two metals or metal alloys from point to point,

grinding the deposit to produce particles varying in relative composition, and

combining the particles with a suitable matrix to produce the paint.

In a fifth aspect, the present invention provides a method of producing the paint according to the first aspect, the method including the steps of:

precipitating particles of the alloy from a solution containing chemical precursors of the alloy, the precipitation conditions (e.g. precursor concentration) varying such that the precipitated particles correspondingly vary in relative composition of the two or more metals, and

combining the precipitated particles with a suitable matrix to produce the paint.

For example, the precipitation conditions may vary over time. Alternatively, the precipitation conditions may vary between batches of the solution.

In a sixth aspect, the present invention provides a method of determining the maximum temperature experienced by the article of the third aspect, the method including the steps of:

exposing the article to temperatures at which at least some of the particles in the paint may melt, either partially or completely,

examining the surface of the article at one or more locations for partially or completely unmelted particles, and

measuring the compositions of the partially or completely unmelted particles to determine the maximum temperature to which the article was exposed at the one or more locations.

The examining and measuring steps can be performed at a plurality of locations to build up a 2-D map of the maximum temperature to which the article was exposed.

The examining step may be performed using electron microscopy, e.g. using secondary electron microscopy.

The measuring step may be performed by spectroscopy, e.g. energy dispersive X-ray spectroscopy, auger electron spectroscopy, X-ray photoelectron spectroscopy, wavelength dispersive X-ray spectroscopy.

Embodiments of the invention will now be described by way of example with reference to the accompanying drawings in which:

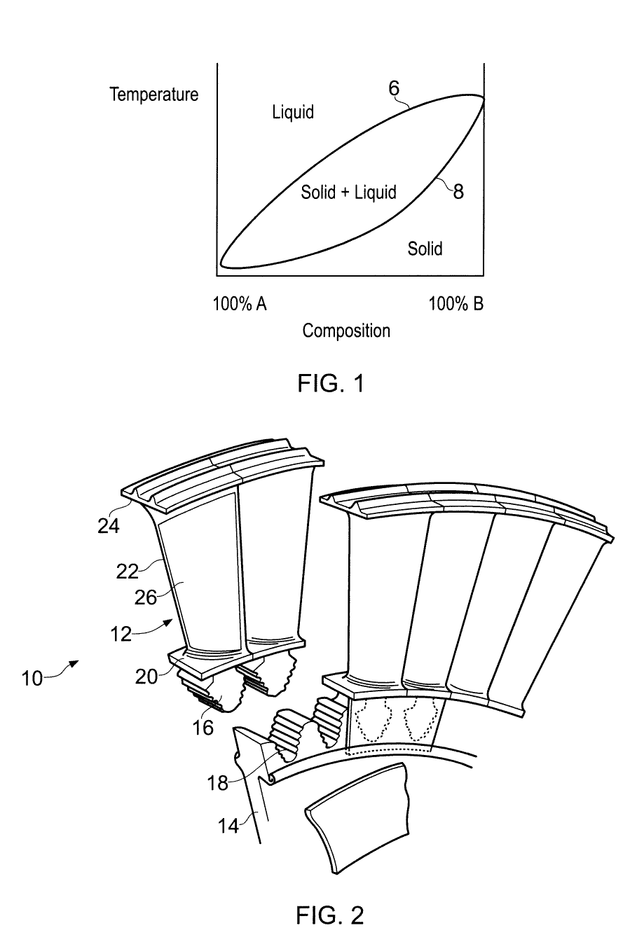

FIG. 1 shows a schematic binary phase diagram for alloys of metals A and B,

FIG. 2 shows a view of part of a rotor of a gas turbine engine, including a number of blades, at least one blade is coated with a temperature indicating paint,

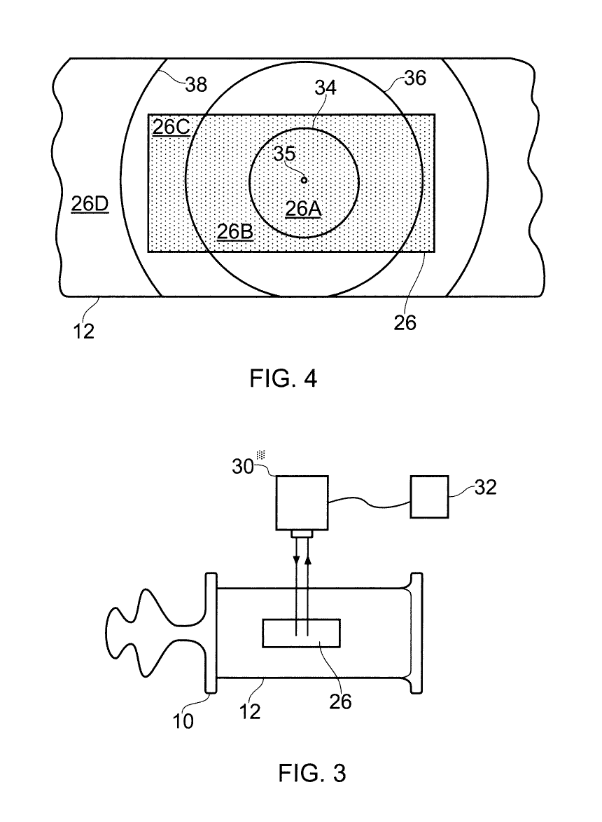

FIG. 3 is a schematic illustration of apparatus for examining and/or measuring the temperature indicating paint,

FIG. 4 is a view on an area of the temperature indicating paint,

A temperature indicating paint according to the present invention includes particles of an alloy of two or more metals. The particles vary in relative composition of the metals such that particles having different compositions have different melting ranges. The temperature indicating paint may include a number of different alloys each of a different metal and composition.

FIG. 1 shows, for example, a schematic binary phase diagram for alloys of metals A and B. The melting point of pure A is lower than the melting point of pure B. Between these melting points a liquidus line 6 and a solidus line 8 extend uninterruptedly across the entire phase diagram, increasing continuously in temperature from A to B. Thus, by providing particles having a continuous distribution of compositions (e.g. from pure A to pure B), a corresponding distribution of particle melting point ranges is obtained. Furthermore, each composition corresponds to a unique melting point range. Alloys having more complicated phase diagrams may be employed, but preferably across the range of compositions exhibited by the particles there is such a one-to-one correspondence between composition and temperature.

The particles may be produced as a powder by a variety of means. For example, well known methods developed for powder metallurgy include spray atomisation, electrolysis and chemical precipitation from solution. Varying the concentration of the powder precursors can then produce the variation in the alloy composition of the resulting powder.

However, an alternative approach is to sputter the metals onto a substrate with a suitable geometry and then grind up the resulting deposit. For example, one possible sputtering arrangement involves positioning sputtering targets of two different metals or metal alloys roughly equidistantly from and at opposite ends of a substrate. This then can produce a gradual change in composition of the deposited metals/alloys across the substrate. The positions of the targets and substrate can be adjusted to achieve the required range of composition on the substrate.

Having produced the powder, the paint is formed by combining the powder with a suitable matrix, which may include components such as inert fillers to reduce interactions between particles in the paint.

Another alternative approach to forming alloy compositions for the temperature indicating paint is to form a number of discrete alloy compositions and mix the compositions together. Thus there may be formed a paint comprising particles of a first composition and particles of a second composition and where each composition has a different melting point or range. The first and second compositions may be of the same metals, but could also be formed of different metals. The number of discrete particle alloy compositions and the specific composition of each particle may be tailored to the particular application for identification of desired temperature points, range or ranges that a component is subjected.

FIG. 2 shows a view of a rotor 10 of a gas turbine engine, including a number of blades 12 mountable on a disc 14 via cooperating dovetail root 16 and slot 18 fixtures. The blade 12 includes an inner platform 20, an aerofoil 22 and an optional shroud 24. In this example the rotor is a turbine section, but the rotor can be a compressor. Indeed it will be apparent that the temperature indicating paint is applicable to any component of the gas turbine engine and to other components of other engines or devices across a very wide range of fields.

In use, hot working gases force against the blades to rotate the rotor and drive a compressor in known fashion. In service and during testing, it is desirable to know the temperatures and temperature gradients experience by the component. Here at least one blade is coated with a temperature indicating paint as described herein. Only a patch of temperature indicating paint 26 is shown, but in other cases all of the aerofoil may be coated or all of the blade can be coated as well as parts of the disc.

The paint is applied to a component, such as a turbine blade or vane, turbine disc, or combustor, and run in an engine. The surface of the component may be pretreated to improve keying of the paint, which can be brushed or sprayed onto the component. Stoving of the paint may be required before the test to bond the paint to the component.

After the test, the paint can be removed from the component for subsequent analysis, for example by peeling off the paint using adhesive tape, or by detaching a removable part of the component itself. Alternatively, the paint on smaller components (such as high pressure turbine blades etc) may be analysed in situ on the component and/or after the component is removed from the engine.

At a given location on the component, particles in the paint with compositions having a solidus point below the maximum temperature reached in this location will have begun to melt and flow, partially losing their original particle shape, while those particles with compositions having a solidus point above the maximum reached will still remain as discrete, unmelted particles. At the same given location on the component, particles in the paint with compositions having a liquidus point below the maximum temperature reached in this location will have completely melted and flowed, losing their original particle shape and/or texture and/or lustre or other measurable parameter such as composition and radiance.

FIG. 3 is a schematic illustration of apparatus for examining and/or measuring the temperature indicating paint. Examination of the paint, for example using a secondary electron microscope 30, can allow these two particle types to be distinguished. Further, the composition of each unmelted or partially melted particle can be identified using an analytical technique such as energy or wavelength spectroscopy (e.g. energy dispersive X-ray spectroscopy, auger electron spectroscopy, X-ray photoelectron spectroscopy, wavelength dispersive X-ray spectroscopy). Thus at the given location, measurement of the compositions of the partially or completely unmelted particles provides a range of compositions with a corresponding range of liquidus and solidus points. The melting point of the partially or completely unmelted particles with the lowest liquidus and solidus points at the location provides a determination of the maximum temperature reached at that location. Further locations on the component can then be selected and the process repeated to produce a map of the maximum surface temperatures experienced. This process can be performed manually or automatically under computer control 32.

Referring to FIG. 4, which is an enlarged view on the temperature indicating paint 26 on the aerofoil 12 of the turbine blade 10. As is well known the turbine blade is subject to high temperature working fluids drivingly passing through rotor and stator sections of gas turbine engines. Lines of equal temperature, or isotherms, have been schematically shown as lines 34, 36 and 38. In this example, the highest temperature experienced by the blade is at the point 35 surrounded by line 34 with decreasing temperature away from this centre 35.

Areas of temperature indicating paint 26 are given the reference numbers 26A, 26B, 26C and 26D and are generally subject to different temperatures. The temperature indicating paint 26 comprises particles of alloys or in some cases pure metals. The alloy composition or single metal varies such that there may be two or more different alloy compositions or single metal particles within the paint. In this example, the temperature indicating paint 26 comprises four different particle types each having different compositions for alloys and therefore four different liquidus and solidus points. The four types or compositions of particles are dispersed throughout the paint 26 and are referred to as alloys W, X, Y and Z. Alloy compositions W, X, Y and Z have increasingly high liquidus and solidus points, such that composition Z has the highest melting point.

After being run in a gas turbine engine, in area 26A, the highest temperature zone, particles having compositions W, X and Y have completely melted, particles having composition Z having a solidus point below the maximum temperature reached in this area will have begun to melt (or partially melted) and flow, partially losing their original particle shape.

In area 26B, the second highest temperature zone, particles having compositions W and X have completely melted, particles having compositions Y having a solidus point below the maximum temperature reached in this area will have begun to melt (or partially melted) and flow, partially losing their original particle shape, while those particles with compositions Z having a solidus point above the maximum reached will still remain as discrete, unmelted particles.

In third highest temperature-exposed area 26C, particles having composition W have completely melted, particles having composition X having a solidus point below the maximum temperature reached in this area will have begun to melt (or partially melted) and flow, partially losing their original particle shape, while those particles with compositions Y and Z having a solidus point above the maximum reached will still remain as discrete, unmelted particles.

In fourth highest temperature-exposed area 26D, particles having composition W having a solidus point below the maximum temperature reached in this area will have begun to melt (or partially melted) and flow, partially losing their original particle shape, while those particles with compositions X, Y and Z having a solidus point above the maximum reached will still remain as discrete, completely unmelted particles.

Thus, for example, by examining the temperature indicating paint 26 using electron microscopy and measuring the particles using spectroscopy it is possible to determine isotherms (34-38), temperature gradients and maximum temperatures experienced by the blade. This method can therefore be used at a plurality of locations to build up a two-dimensional or graphical map of the temperature to which the article was exposed and particularly illustrate maximum temperature location(s).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A temperature indicating paint which is spreadable onto a surface of an article, the paint including particles of an alloy of two or more metals, the particles varying in relative composition of the metals such that particles having different compositions have different melting points or ranges.

1A-1B. (canceled)

2. A paint according to claim 1, wherein particles having different compositions are distinguishable from each other by spectroscopy.

3. A paint according to claim 1, wherein the alloy is an alloy of just two metals.

4. A paint according to claim 1, wherein the particles provide a continuous distribution of compositions and a corresponding continuous distribution of solidus and liquidus points.

5. A paint according to claim 4, wherein one end point of the composition distribution has a lower melting point than the other end point of the composition distribution, and the alloy has continuously increasing solidus and liquidus lines between the end points.

6. A paint according to any claim 1, wherein the solidus or liquidus points of the particles are at least 500° C.

7. A paint according to claim 1, wherein the solidus or liquidus points of the particles are at most 1400° C.

8. A method for painting the surface of an article comprising painting the surface of the article using the paint according to claim 1.

9. An article having a surface painted with the paint according to claim 1.

10. A method of producing the paint according to claim 1, the method including the steps of:
sputtering a substrate with two metals or metal alloys having different compositions such that a sputtered deposit is formed on the substrate, the sputtering conditions being selected such that the deposit varies in relative composition of the two metals or metal alloys from point to point,
grinding the deposit to produce particles varying in relative composition, and
combining the particles with a suitable matrix to produce the paint.

11. A method of producing the paint according to claim 1, the method including the steps of:
precipitating particles of the alloy from a solution containing chemical precursors of the alloy, the precipitation conditions varying such that the precipitating particles correspondingly vary in relative composition of the two or more metals, and
combining the precipitated particles with a suitable matrix to produce the paint.

12. A method of determining the maximum temperature experienced by the article of claim 9, the method including the steps of:
exposing the article to temperatures at which at least some of the particles in the paint may melt, either partially or completely
examining the surface of the article at one or more locations for partially or completely unmelted particles, and
measuring the compositions of the partially or completely unmelted particles to determine the maximum temperature to which the article was exposed at the one or more locations.

13. A method according to claim 12, wherein the examining and measuring steps are performed at a plurality of locations to build up a 2-D map of the maximum temperature to which the article was exposed.

14. A method according to claim 12, wherein the examining step is performed using electron microscopy.

15. A method according to claim 12, wherein the measuring step is performed by spectroscopy.
